(19) United States
(12) Patent Application Publication
(10) Pub. No.: US 2022/0402457 A1
(43) Pub. Date: Dec. 22, 2022

(54) WEBBING TAKE-UP DEVICE

(71) Applicant: KABUSHIKI KAISHA TOKAI-RIKA-DENKI-SEISAKUSHO, Aichi (JP)

(72) Inventors: Yoshiteru SAKAGUCHI, Aichi (JP); Hayato UCHIHORI, Aichi (JP); Masanori NAGAMINE, Aichi (JP); Kengo MIURA, Aichi (JP); Misa NAGURA, Aichi (JP)

(21) Appl. No.: 17/763,571

(22) PCT Filed: Oct. 22, 2020
(86) PCT No.: PCT/JP2020/039710

§ 371 Date: Mar. 24, 2022

(30) Foreign Application Priority Data
Nov. 1, 2019 (JP) 2019-200245

(51) Int. Cl. B60R 22/46

(52) U.S. Cl. CPC B60R 22/4628

(57) ABSTRACT

A webbing take-up device is provided that includes a spool configured to take up a webbing of a seatbelt device, a rotating member configured to rotate the spool in the take-up direction, a tube-shaped cylinder, a moving member provided inside the cylinder that, when moved by a pressurized fluid, causes the rotating member to rotate by engaging with a side of the rotating member. At the end of its movement through the cylinder, the moving member abuts and moves a stopper inside a recess, suppressing movement of the moving member without an engaging member jabbing or biting into the moving member.

### TECHNICAL FIELD

The present disclosure relates to a webbing take-up device in which a spool is rotated in a take-up direction by rotating a rotating member.

### BACKGROUND ART

For example, a webbing take-up device disclosed in International Publication (WO) No. 2019/026426 includes a stopper. A moving member is moved toward its length direction leading end side, and the stopper is pressed and moved by a length direction leading end side portion of the moving member. When the stopper is moved, the stopper jabs or bites into the moving member further toward a length direction base end side of the moving member than an engagement location of the moving member with a rotating member. Movement of the moving member is thereby suppressed.

### SUMMARY OF INVENTION

### Technical Problem

The present disclosure obtains a webbing take-up device that enables movement of a moving member to be suppressed, even without an engaging member jabbing or biting into the moving member.

### Solution to Problem

A webbing take-up device of a first aspect of the present disclosure includes: a spool configured to take up a webbing of a seatbelt device by being rotated in a take-up direction; a rotating member configured to rotate the spool in the take-up direction by being rotated toward one side; a tube-shaped cylinder open at an axial direction leading end side; a fluid supply unit provided at an axial direction base end side of the cylinder and configured to supply a fluid to an interior of the cylinder in a vehicle emergency; a moving member provided inside the cylinder and configured to be moved toward the axial direction leading end side of the cylinder under pressure of the fluid so as to cause the rotating member to rotate toward the one side by engaging with the rotating member; an engaging member provided further toward a movement direction side of the moving member than an engagement location of the moving member with the rotating member, and the engaging member being configured to be moved toward the engagement location of the moving member with the rotating member by being pressed by a portion of the moving member that has disengaged from the rotating member; and a recess that is formed in a portion of the moving member located toward the axial direction base end side of the cylinder and that is open toward the engaging member in a state in which the moving member has emerged from the axial direction leading end of the cylinder, the engaging member being configured to enter inside the recess on being pressed and moved by the moving member.

In the webbing take-up device of the first aspect of the present disclosure, the engaging member is provided further toward the movement direction side of the moving member than the engagement location of the moving member with the rotating member. The engaging member is pressed by a portion of the moving member that has disengaged from the rotating member, and the engaging member is moved toward the engagement location of the moving member with the rotating member as a result.

The recess is formed in a portion of the moving member located toward the axial direction base end side of the cylinder. When the formation portion where the recess is formed in the moving member emerges from the axial direction leading end of the cylinder, the recess is open toward the engaging member. When the engaging member that has been pressed and moved by the moving member enters inside the recess, the engaging member supports an inner portion of the recess from the movement direction side of the moving member inside the recess. Movement of the moving member is thereby suppressed.

This entry of the engaging member inside the recess in the moving member enables movement of the moving member to be suppressed. Thus, in a state in which the engaging member has entered inside the recess in the moving member, this suppression of the movement of the moving member by the engaging member can be suppressed from being affected by the movement speed and so on of the moving member.

A webbing take-up device of a second aspect of the present disclosure is the webbing take-up device of the first aspect, wherein plural of the recesses are provided along the movement direction of the moving member.

In the webbing take-up device of the second aspect of the present disclosure, the plural recesses are provided along the movement direction of the moving member. Thus, even if the engaging member does not enter the recess on the movement direction side of the moving member, movement of the moving member can still be suppressed provided that the engaging member enters a recess toward the opposite side of the moving member to this movement direction-side recess.

A webbing take-up device of a third aspect of the present disclosure is the webbing take-up device of the first aspect or the second aspect, wherein the recess has a ring shape that is continuous around a circumferential direction of the moving member.

In the webbing take-up device of the third aspect of the present disclosure, the recess has a ring shape that is continuous around the circumferential direction (an axis encircling direction, wherein the movement direction of the moving member is the axial direction) of the moving member. Thus, the engaging member can be made to enter the recess without precise positioning of the moving member in the circumferential direction of the moving member when the moving member is placed in the cylinder.

### Advantageous Effects of Invention

As described above, by causing the engaging member to enter the recess in the moving member, the webbing take-up device according to the present disclosure enables movement of the moving member to be suppressed without the engaging member jabbing or biting into the moving member.

### BRIEF DESCRIPTION OF DRAWINGS

FIG. 1 is an exploded perspective view illustrating a webbing take-up device according to a first exemplary embodiment.

FIG. 2 is a cross-section sectioned along line 2-2 in FIG. 3.

FIG. 3 is a side view of an inside of a cover plate as viewed from a vehicle front side, illustrating a state in which a moving member has moved out of an axial direction leading end of a cylinder.

FIG. 4 is a side view corresponding to FIG. 3, illustrating a state in which a conical portion of the moving member has abutted a second tooth of a second rotating section of a rotating member.

FIG. 5 is a side view corresponding to FIG. 3, illustrating a state in which first teeth and second teeth of the rotating member are biting or jabbing into the moving member.

FIG. 6 is a side view corresponding to FIG. 3, illustrating a state in which the moving member has abutted a stopper.

FIG. 7 is a side view corresponding to FIG. 3, illustrating a state in which the stopper has entered inside a recess in the moving member.

FIG. 8 is a side view corresponding to FIG. 3, illustrating a state in which the stopper is jabbing or biting into the moving member inside the recess.

FIG. 9A is a face-on view of a length direction base end side portion of a moving member according to a second exemplary embodiment.

FIG. 9B is a perspective view of a length direction base end side portion of a moving member according to a third exemplary embodiment.

FIG. 9C is a perspective view of a length direction base end side portion of a moving member according to a fourth exemplary embodiment.

### DESCRIPTION OF EMBODIMENTS

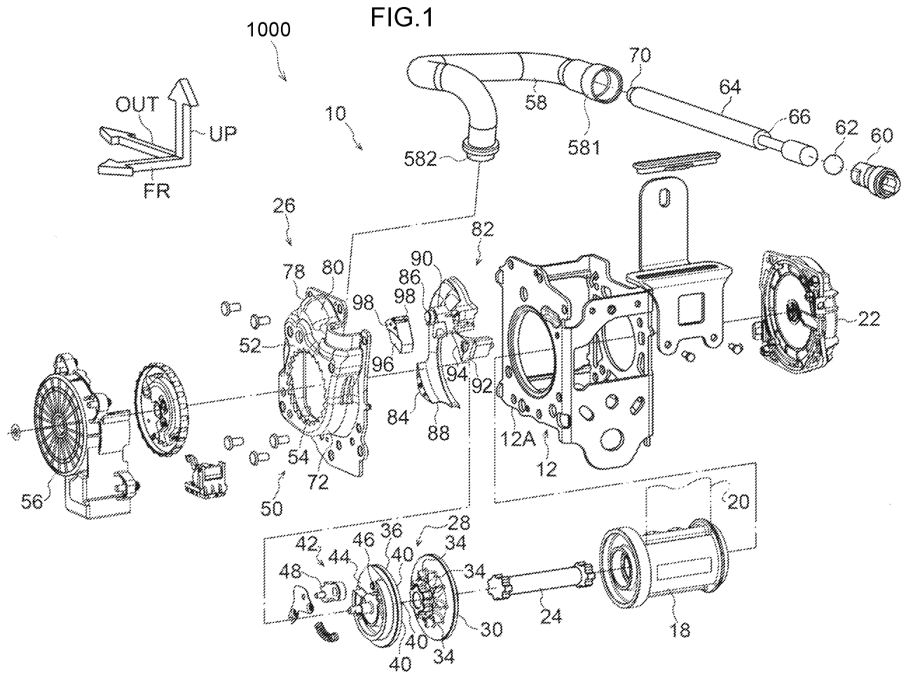

Explanation follows regarding exemplary embodiments of the present disclosure, with reference to FIG. 1 to FIG. 9. Note that in each of the drawings, the arrow FR indicates a vehicle front side, the arrow OUT indicates a vehicle width direction outside, and the arrow UP indicates a vehicle upper side of a vehicle applied with a webbing take-up device 10. Moreover, in each of the drawings, the arrow A indicates a take-up direction, this being a rotation direction of a spool 18 when the spool 18 takes up a webbing 20, and the arrow B indicates a pull-out direction, this being the opposite direction to the take-up direction. Furthermore, the arrow C indicates a movement direction of a stopper 96 at a length direction leading end side of the stopper 96.

Note that in the following explanation of the exemplary embodiments, in cases in which a subsequent exemplary embodiment has basically the same locations as those of an exemplary embodiment that has already been described, the same reference numerals are allocated thereto and detailed explanation thereof is omitted.

### Configuration of First Exemplary Embodiment

As illustrated in FIG. 1, the webbing take-up device 10 according to the present exemplary embodiment includes a frame 12. The frame 12 is fixed to a vehicle lower side portion of a center pillar (not illustrated in the drawings), serving as a vehicle body of the vehicle.

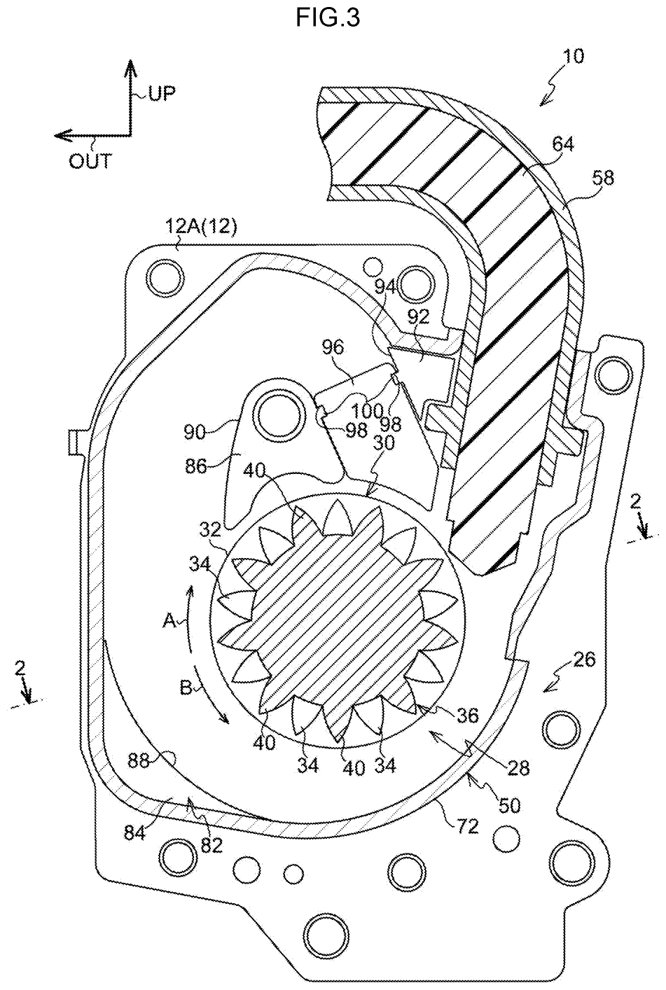

The spool 18 is provided to the frame 12. The spool 18 is formed in a substantially circular tube shape, and is capable of rotating about its central axial line (in the arrow A direction and arrow B direction in FIG. 3, etc.). A length direction base end portion of the elongated belt-shaped webbing 20 is anchored to the spool 18. The webbing 20 is taken up onto the spool 18 from its length direction base end side when the spool 18 is rotated in the take-up direction (the arrow A direction in FIG. 3, etc.). A length direction leading end side of the webbing 20 extends from the spool 18 toward the vehicle upper side, passes through a slit formed in a through anchor (not illustrated in the drawings) supported by the center pillar at the vehicle upper side of the frame 12, and folds back on itself toward the vehicle lower side.

A length direction leading end portion of the webbing 20 is anchored to an anchor plate (not illustrated in the drawings). The anchor plate is formed of a sheet metal material such as a ferrous metal, and is fixed to a floor section (not illustrated in the drawings) of the vehicle, or to a framework member or the like of a seat (not illustrated in the drawings) applied with the webbing take-up device 10.

A vehicle seatbelt device 1000 applied with the webbing take-up device 10 also includes a buckle device (not illustrated in the drawings). The buckle device is provided on the vehicle width direction inside of the seat (not illustrated in the drawings) applied with the webbing take-up device 10. In a state in which the webbing 20 has been wrapped across the body of an occupant seated in the seat, a tongue (not illustrated in the drawings) provided to the webbing 20 is engaged with the buckle device, such that the webbing 20 is worn over the body of the occupant.

As illustrated in FIG. 3, a spring housing 22 is provided at the vehicle rear side of the frame 12. A spool biasing member such as a spiral spring (not illustrated in the drawings) is provided inside the spring housing 22. The spool biasing member either directly or indirectly engages with the spool 18, such that the spool 18 is biased in the take-up direction (the arrow A direction in FIG. 3, etc.) by the biasing force of the spool biasing member.

The webbing take-up device 10 also includes a torsion bar 24 configuring a force limiter mechanism. A vehicle rear side portion of the torsion bar 24 is disposed inside the spool 18 and is linked to the spool 18 in a state in which rotation of the torsion bar 24 relative to the spool 18 is limited. A vehicle front side portion of the torsion bar 24 passes through a hole formed in the frame 12 and extends toward the outside (vehicle front side) of the frame 12.

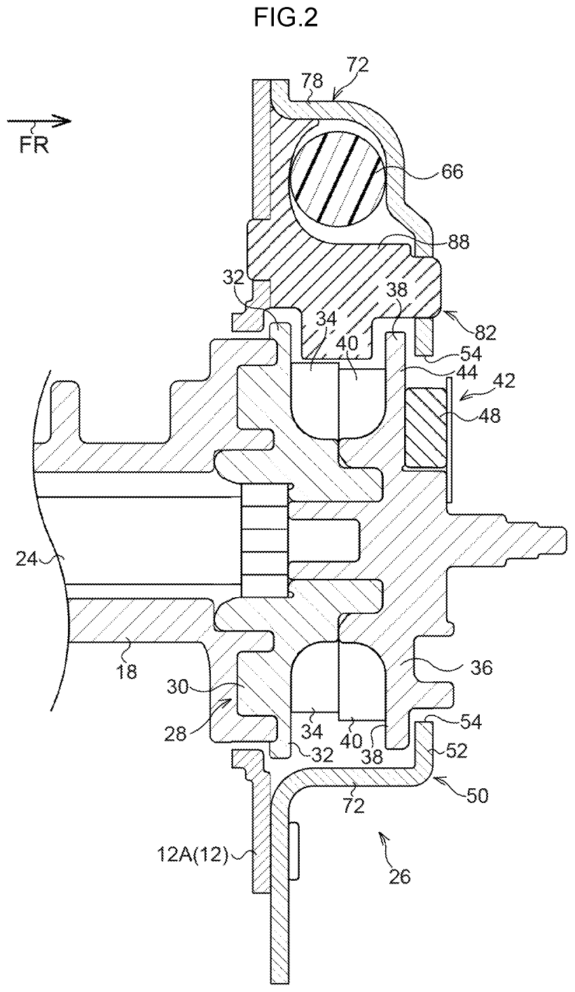

A rotating member 28 of a pre-tensioner 26 is provided at the vehicle front side of the frame 12. As illustrated in FIG. 1 and FIG. 2, the rotating member 28 includes a first rotating section 30. The first rotating section 30 is disposed coaxially to the spool 18. The vehicle front side portion of the torsion bar 24 is coupled to the first rotating section 30, such that the rotating member 28 is limited from rotating relative to the vehicle front side portion of the torsion bar 24. The first rotating section 30 of the rotating member 28 includes a first flange 32. The first flange 32 is formed in a circular plate shape. A thickness direction of the first flange 32 corresponds to the vehicle front-rear direction (the arrow FR direction and the opposite direction thereto in FIG. 1 and FIG. 2). Plural first teeth 34 are provided at the vehicle front side (the arrow FR direction side in FIG. 1 and FIG. 2) of the first flange 32. The first teeth 34 are arranged at predetermined intervals around a central axial line of the first flange 32 (namely, around a central axial line of the first rotating section 30), and are integrally formed to the first flange 32.

The rotating member 28 is configured of both the first rotating section 30 and a second rotating section 36 that is provided at the vehicle front side of the first rotating section 30. The second rotating section 36 includes a second flange 38. The second flange 38 is formed in a circular plate shape. The second flange 38 has the same shape as the first flange 32, and is disposed coaxially to the first flange 32 at the vehicle front side of the first rotating section 30 so as oppose the first flange 32.

Plural second teeth 40 are provided at the vehicle rear side of the second flange 38 (the opposite side to the arrow FR direction side in FIG. 1 and FIG. 2) so as to be at the vehicle front side of the first teeth 34 of the first rotating section 30. The second teeth 40 are integral to the second flange 38. The second teeth 40 are formed at predetermined intervals around a central axial line of the second rotating section 36. As viewed along the central axial line direction of the rotating member 28, each of the second teeth 40 is disposed at substantially the center between first teeth 34 of the first rotating section 30 that are adjacent to one another about the central axial line of the first rotating section 30 of the rotating member 28. In this state, the second rotating section 36 is coupled to the first rotating section 30, such that movement of the second rotating section 36 relative to the first rotating section 30 is limited.

A vehicle front side portion of the second rotating section 36 configures a lock base 44 of a locking mechanism 42. The lock base 44 includes a lock pawl 48. The lock pawl 48 is supported by a boss 46 formed to the lock base 44, and is capable of swinging centered on the boss 46.

A cover plate 50 that configures both the locking mechanism 42 and the pre-tensioner 26 is fixed to a leg plate 12A on the vehicle front side of the frame 12. The cover plate 50 is open toward the vehicle rear side, and a bottom plate 52 of the cover plate 50 opposes the frame 12 in a state spaced apart from the vehicle front side of the frame 12. A ratchet hole 54 is formed in the bottom plate 52. Ratchet teeth are formed to an inner peripheral portion of the ratchet hole 54. When the lock pawl 48 of the lock base 44 is swung in one direction about the boss 46, a leading end portion of the lock pawl 48 meshes with the ratchet teeth in the ratchet hole 54. Rotation of the lock base 44 in the pull-out direction (the arrow B direction in FIG. 3, etc.) is thereby limited, such that rotation of the spool 18 in the pull-out direction is indirectly limited.

A sensor holder 56 of the locking mechanism 42 is provided at the vehicle front side of the cover plate 50. The sensor holder 56 is open toward the vehicle rear side, and is either directly fixed to the frame 12, or indirectly fixed thereto through the cover plate 50. Respective components configuring a sensor mechanism to detect an emergency state of the vehicle are housed inside the sensor holder 56. When the sensor mechanism inside the sensor holder 56 is actuated in a vehicle emergency, the lock pawl 48 of the lock base 44 is swung in the one direction about the boss 46 coordinated with rotation of the lock base 44 of the locking mechanism 42 in the pull-out direction.

The webbing take-up device 10 includes a cylinder 58 serving as a tube-shaped member configuring the pre-tensioner 26. The cylinder 58 has a circular tube shape. An axial direction base end 581 of the cylinder 58 is disposed at the vehicle upper-rear side of the frame 12. A micro gas generator 60 (the micro gas generator 60 is hereafter referred to as the “MGG 60”) serving as a fluid supply unit is inserted into the axial direction base end 581 of the cylinder 58. The MGG 60 is electrically connected to a collision detection sensor provided to the vehicle via an ECU serving as a control unit (none of which are illustrated in the drawings). The MGG 60 is actuated by the ECU when the collision detection sensor has detected an impact during a vehicle collision, such that gas serving as an example of a fluid generated in the MGG 60 is supplied inside the cylinder 58.

A ball seal 62 serving as a piston is disposed inside the cylinder 58 of the pre-tensioner 26. The ball seal 62 is formed of a synthetic resin material, and the ball seal 62 has a substantially spherical shape in a state in which load is not being applied to the ball seal 62. The sealing ball 62 partitions the space inside the cylinder 58 into a space further toward the axial direction base end 581 side than the ball seal 62 and a space further toward an axial direction leading end 582 side than the ball seal 62.

When the MGG 60 is actuated, gas generated by the MGG 60 is supplied into the cylinder 58 between the MGG 60 and the ball seal 62. When the internal pressure of the cylinder 58 between the MGG 60 and the ball seal 62 rises as a result, the ball seal 62 is moved toward the axial direction leading end 582 side of the cylinder 58 and is compressed and deformed in the axial direction of the cylinder 58.

A moving member 64 is disposed inside the cylinder 58 of the pre-tensioner 26. The moving member 64 is formed of a synthetic resin material, and is capable of deforming on being subjected to an external force. The moving member 64 is disposed further toward the axial direction leading end 582 side of the cylinder 58 than the ball seal 62. Thus, when the ball seal 62 is moved toward the axial direction leading end side 582 of the cylinder 58, the moving member 64 is pressed by the ball seal 62 and is moved toward the axial direction leading end 582 side of the cylinder 58. The moving member 64 is formed in a cylindrical rod shape.

A recess 66 is formed in a length direction base end side (ball seal 62-side) portion of the moving member 64. The recess 66 is formed continuously around a circumferential direction of the moving member 64 so as to open onto an outer peripheral face of the moving member 64. Inside the recess 66, a base end side face of the recess 66 in the length direction of the moving member 64 and a leading end side face of the recess 66 in the length direction of the moving member 64 oppose one another in the length direction of the moving member 64.

An axial direction intermediate portion of the cylinder 58 of the pre-tensioner 26 is bent. The axial direction leading end 582 of the cylinder 58 is disposed at the vehicle upper-front side of the vehicle front side of the frame 12 so as to be retained sandwiched between the cover plate 50 and the frame 12. The axial direction leading end 582 of the cylinder 58 is open toward substantially the vehicle lower side (more specifically, in a direction sloped toward the vehicle width direction outside with respect to the vehicle lower side).

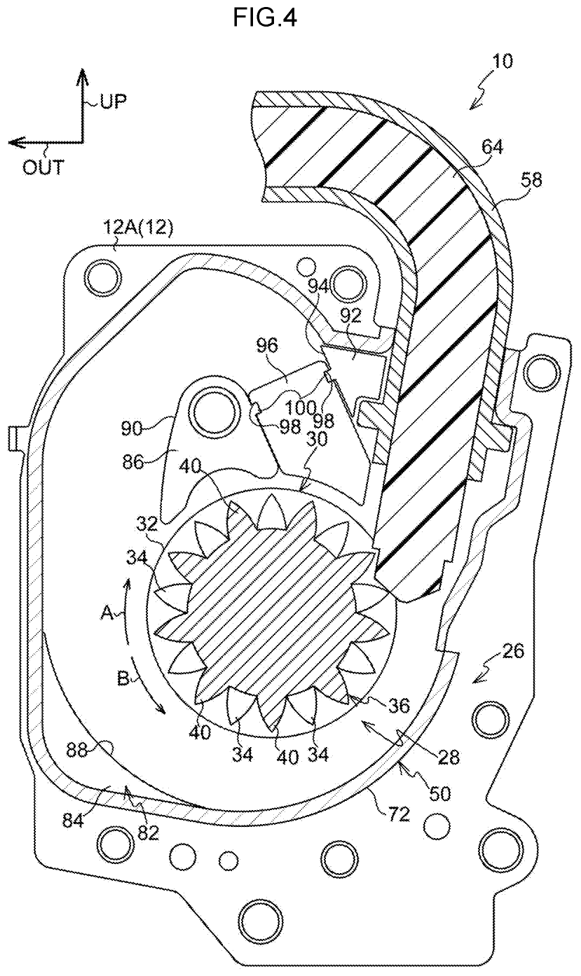

When the moving member 64 is further pressed and moved by the ball seal 62 in a state in which the moving member 64 has reached the axial direction leading end 582 of the cylinder 58, as illustrated in FIG. 3, the moving member 64 moves out of the axial direction leading end 582 of the cylinder 58 toward the vehicle lower side, and enters inside the cover plate 50. When the moving member 64 is moved further toward the vehicle lower side in this state, as illustrated in FIG. 4, a length direction leading end side portion of the moving member 64 abuts a first tooth 34 of the first rotating section 30 or a second tooth 40 of the second rotating section 36 of the rotating member 28.

In this state, this first tooth 34 or second tooth 40 is pressed toward the vehicle lower side by the moving member 64, such that rotation force in the take-up direction (the arrow A direction in FIG. 4) is applied to the rotating member 28 from the moving member 64. The rotating member 28 is thereby rotated in the take-up direction, and the moving member 64 is moved further toward the vehicle lower side by the pressure from the ball seal 62.

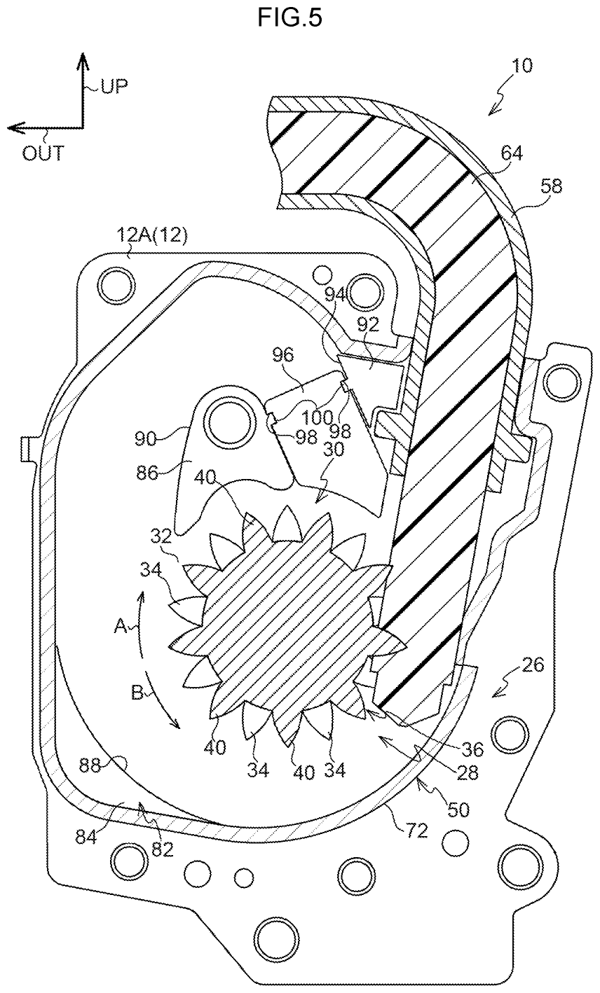

Due to the moving member 64 being moved toward the vehicle lower side and the rotating member 28 being rotated in the take-up direction in this manner, as illustrated in FIG. 5, one tooth out of the first teeth 34 of the first rotating section 30 or the second teeth 40 of the second rotating section 36 of the rotating member 28 bites or jabs into the moving member 64. When the moving member 64 is moved further toward the vehicle lower side in this state, rotation force in the take-up direction is further applied to the rotating member 28, such that the rotating member 28 is further rotated in the take-up direction.

As illustrated in FIG. 1 and FIG. 2, the cover plate 50 includes the bottom plate 52, serving as a lever support portion (suppression member support portion). The bottom plate 52 is plate shaped, and a thickness direction of the bottom plate 52 broadly corresponds to the vehicle front-rear direction (the arrow FR direction and the opposite direction thereto in FIG. 1 and FIG. 2). The cover plate 50 also includes a side wall 72 configuring a guide unit. The side wall 72 is provided around an outer peripheral portion of the bottom plate 52 of the cover plate 50. As illustrated in FIG. 2, FIG. 3, and so on, the rotating member 28 is disposed at an inner side of the side wall 72.

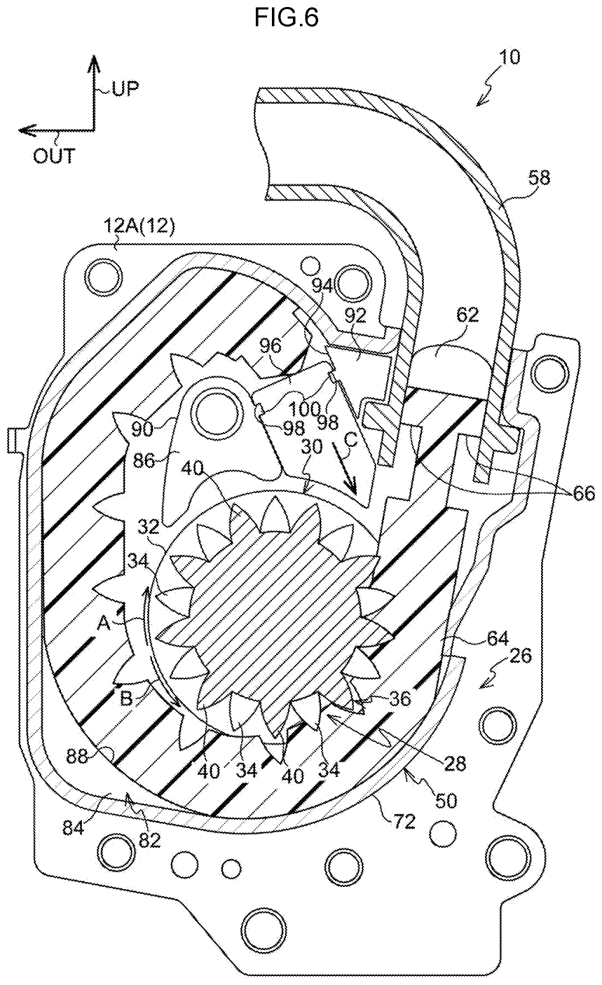

As illustrated in FIG. 3, a guide member 82 that, together with the side wall 72, configures the guide unit is provided inside the cover plate 50. The guide member 82 includes a first guide section 84 and a second guide section 86. The first guide section 84 is provided at a vehicle lower side end of a vehicle width direction outer end portion of the inner side of the side wall 72. The first guide section 84 includes a first guide face 88. The first guide face 88 is curved about a center of curvature at the vehicle upper side and vehicle width direction inside of the first guide face 88. As illustrated in FIG. 6, when the moving member 64 has extended out of the axial direction leading end 582 of the cylinder 58 by a predetermined length, the moving member 64 is moved while being guided by an inner face of the cover plate 50 at the side wall 72 of the cover plate 50 and by the first guide face 88 of the first guide section 84.

The second guide section 86 of the guide member 82 is provided further toward the vehicle upper side than the first guide section 84. A vehicle width direction outer face of the second guide section 86, a vehicle upper face of the second guide section 86, and a vehicle width direction inner face of the second guide section 86 configure a second guide face 90. As illustrated in FIG. 6 to FIG. 8, at a location further toward the vehicle upper side than a vehicle vertical direction intermediate portion of the side wall 72 of the cover plate 50, the moving member 64 enters between an inner face of the side wall 72 and a portion of the second guide face 90 of the second guide section 86 that faces toward the vehicle width direction outside, and is moved while being guided by the inner face of the side wall 72 and by the second guide face 90 of the second guide section 86.

The guide member 82 also includes a third guide section 92. The third guide section 92 includes a third guide face 94. The third guide face 94 opposes a vehicle width direction inside-facing portion of the second guide face 90 of the second guide section 86. When the moving member 64 passes a vehicle uppermost side portion of the second guide section 86, the moving member 64 is guided by the vehicle width direction inside-facing portion of the second guide face 90 of the second guide section 86 and by the third guide face 94 of the third guide section 92, so as to move in a direction inclined toward the vehicle lower side with respect to the vehicle width direction inside.

The stopper 96, serving as an engaging member, is provided between the second guide section 86 and the third guide section 92 of the guide member 82. The stopper 96 has a substantially block shape. A thickness direction of the stopper 96 in an initial state (the state illustrated in FIG. 3) of the stopper 96 is a direction broadly opposing the second guide face 90 of the second guide section 86 and the third guide face 94 of the third guide section 92 of the guide member 82. A width direction of the stopper 96 in the initial state of the stopper 96 is broadly the vehicle front-rear direction (the arrow FR direction and the opposite direction thereto in FIG. 1, and a page depth direction and the opposite direction thereto in FIG. 3).

As illustrated in FIG. 3, a pair of grooves 98 are formed in the stopper 96. One of the grooves 98 is formed in one thickness direction side face of the stopper 96 so as to open onto one thickness direction side of the stopper 96. The other of the grooves 98 is formed in another thickness direction side face of the stopper 96 so as to open onto the other thickness direction side of the stopper 96.

Protrusions 100 are contained inside these grooves 98. One of the protrusions 100 is formed projecting out from a portion of the second guide face 90 of the second guide section 86 of the guide member 82 that opposes the third guide face 94 of the third guide section 92. The other of the protrusions 100 is formed projecting out from the third guide face 94 of the third guide section 92 of the guide member 82. Thus, in the initial state of stopper 96 (the state illustrated in FIG. 3), the stopper 96 is retained by the guide member 82.

At a portion of the stopper 96 that is further toward its length direction leading end side (the arrow C direction side in FIG. 6, etc.) than a length direction intermediate portion thereof, one thickness direction side face of the stopper 96 is curved about a center of curvature that is further toward the vehicle lower side than the one thickness direction side face of the stopper 96. A length direction leading end of the stopper 96 is configured by a planar face that is substantially parallel to the axial direction of the cylinder 58 at the axial direction leading end 582 of the cylinder 58.

As illustrated in FIG. 3, the stopper 96 is disposed as described above between the second guide face 90 of the second guide section 86 and the third guide face 94 of the third guide section 92 of the guide member 82. Thus, when the stopper 96 is pressed from a length direction base end side of the stopper 96 by the moving member 64 such that the protrusions 100 inside the grooves 98 snap, the stopper 96 is moved toward one length direction side. The stopper 96 is moved closer toward an engagement location of the moving member 64 with the first teeth 34 and the second teeth 40 of the rotating member 28 as a result.

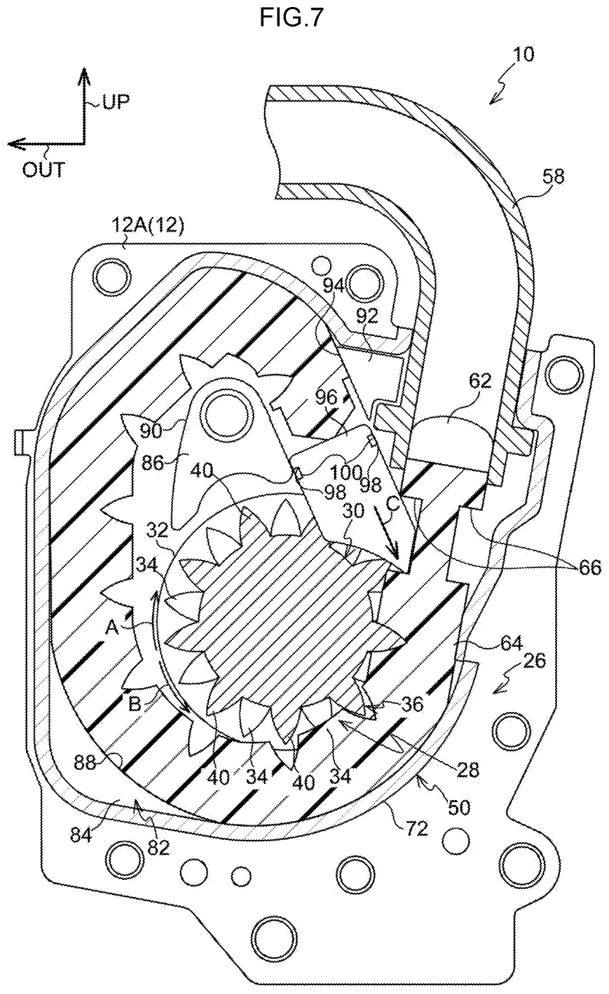

Note that, as illustrated in FIG. 7, a formation position where the recess 66 is formed in the moving member 64 described previously is set such that, when the stopper 96 is pressed by a length direction leading end of the moving member 64 such that the stopper 96 is moved toward its length direction leading end side as far as a movement trajectory of the moving member 64, the length direction leading end of the stopper 96 opposes the recess 66 in the moving member 64.

### Operation and Advantageous Effects of First Exemplary Embodiment

Next, explanation follows regarding operation and advantageous effects of the present exemplary embodiment.

In the webbing take-up device 10, high pressure gas is supplied inside the cylinder 58 from the MGG 60 the instant the MGG 60 of the pre-tensioner 26 is actuated by the ECU in a vehicle collision, this being an example of a vehicle emergency. When the ball seal 62 is moved toward the axial direction leading end 582 side of the cylinder 58 under the pressure of the gas, the moving member 64 is pressed by the ball seal 62, such that the moving member 64 is moved toward the axial direction leading end 582 side of the cylinder 58.

Due to the moving member 64 being moved toward the axial direction leading end 582 side of the cylinder 58, the length direction leading end side portion of the moving member 64 moves out of the axial direction leading end 582 of the cylinder 58 and toward the vehicle lower side, and the length direction leading end side portion of the moving member 64 abuts a first tooth 34 or second tooth 40 of the rotating member 28 (see FIG. 4). When this first tooth 34 or second tooth 40 of the rotating member 28 is being pressed toward the vehicle lower side by the length direction leading end side portion of the moving member 64 in this manner, rotation force in the take-up direction (the arrow A direction in FIG. 4, etc.) is applied to the rotating member 28 from the moving member 64. The rotating member 28 is rotated in the take-up direction as a result.

Moreover, due to the rotating member 28 rotating in the take-up direction as illustrated in FIG. 5, out of the plural first teeth 34 and second teeth 40 of the rotating member 28, first teeth 34 and second teeth 40 that are further toward the pull-out direction side (the arrow B direction side in FIG. 4, etc.) than the first tooth 34 or second tooth 40 being pressed by the moving member 64 bite or jab into the moving member 64 from the outer peripheral face of the moving member 64 toward a radial direction central side of the moving member 64.

Further rotation force in the take-up direction is applied to the rotating member 28 due to the moving member 64, into which the first tooth 34 or second tooth 40 is biting or jabbing, being moved further toward the vehicle lower side, such that the rotating member 28 is rotated further in the take-up direction (the arrow A direction in FIG. 5, etc.). This rotation of the rotating member 28 in the take-up direction is transmitted to the spool 18 through the torsion bar 24, such that the spool 18 is rotated in the take-up direction. The webbing 20 is thus taken up onto the spool 18, increasing the restraining force on the occupant from the webbing 20.

When the moving member 64 moves along the inner side of the side wall 72 of the cover plate 50 due to the moving member 64 being pressed by the ball seal 62, as illustrated in FIG. 6, the length direction leading end of the moving member 64 passes between the side wall 72 of the cover plate 50 and the second guide face 90 of the second guide section 86 of the guide member 82 and abuts the length direction base end of the stopper 96. When the moving member 64 attempts to move toward its length direction leading end side in this state, the protrusions 100 respectively formed to the second guide section 86 and the third guide section 92 of the guide member 82 are pressed by inner walls of the grooves 98 in the stopper 96, and snap as a result. This snapping of the protrusions 100 releases the retention of the stopper 96 by the guide member 82, such that the stopper 96 is moved toward the length direction leading end side of the stopper 96 by the pressing force from the moving member 64.

When the stopper 96 accordingly moves to a position where it can contact the outer peripheral face of the moving member 64, the length direction leading end of the stopper 96 opposes the recess 66 in the length direction base end side portion of the moving member 64. When the stopper 96 is moved from this state, as illustrated in FIG. 7, the length direction leading end side portion of the stopper 96 enters inside the recess 66 in the moving member 64. In this state, the stopper 96 abuts an inner face of the recess 66 in the length direction base end side portion of the moving member 64. Movement of the moving member 64 toward its length direction leading end side is suppressed as a result.

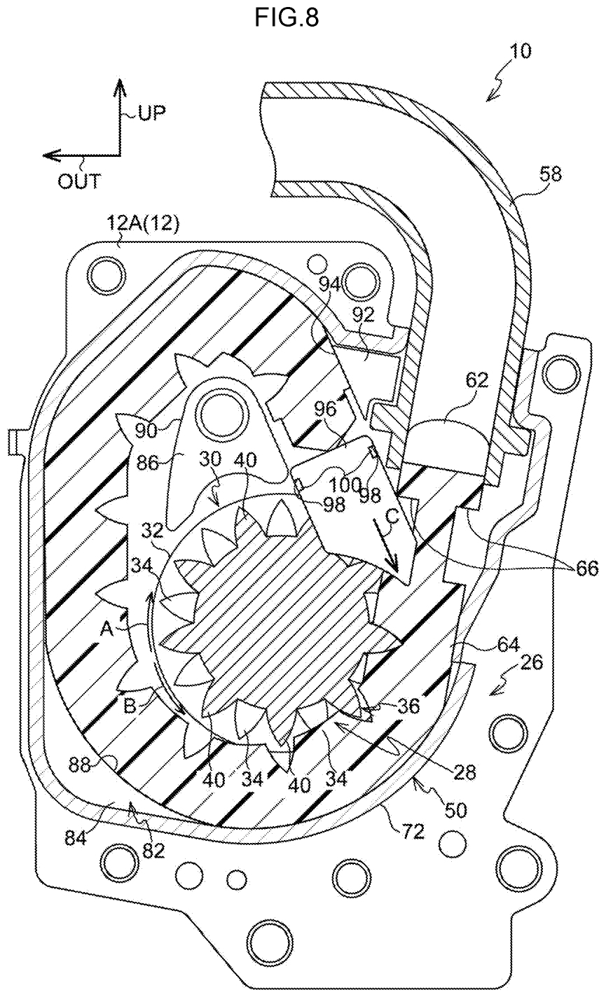

When the stopper 96 is moved further in this state, as illustrated in FIG. 8, the length direction leading end of the stopper 96 bites or jabs into the moving member 64 from a bottom portion of the recess 66 in the moving member 64. Movement of the moving member 64 toward its length direction leading end side is further suppressed as a result. Furthermore, in this state, the stopper 96 enters an engagement location of the moving member 64 with the first teeth 34 and the second teeth 40 of the rotating member 28. Rotation of the rotating member 28 in the take-up direction is suppressed, and movement of the moving member 64 toward its length direction leading end side is further suppressed, as a result.

Movement of the moving member 64 toward its length direction leading end side is suppressed in this manner. This enables the length direction base end of the moving member 64 to be suppressed from moving so much that the moving member 64 comes out of the axial direction leading end 582 of the cylinder 58. This enables gas supplied into the cylinder 58 from the MGG 60 to be suppressed from escaping through the axial direction leading end 582 of the cylinder 58.

Moreover, in the present exemplary embodiment, the length direction leading end of the stopper 96 that is pressed and moved by the moving member 64 enters inside the recess 66 in the moving member 64. When the length direction leading end of the stopper 96 enters inside the recess 66 in the moving member 64 in this manner, the length direction leading end of the stopper 96 does not abut an outer peripheral portion of the moving member 64 to any great extent. This enables the stopper 96 to enter inside the recess 66 in the moving member 64 even in a state in which the moving member 64 is moving toward its length direction leading end side.

Thus, for example, even if the amount, rate, and so on of gas ejected by the MGG 60 is raised, the length direction base end of the moving member 64 can be suppressed from coming out of the axial direction leading end 582 of the cylinder 58 without having to increase the overall length of the moving member 64. This enables the amount, rate, and so on of gas ejected by the MGG 60 to be changed without having to alter the configuration of the pre-tensioner 26 and so on.

Furthermore, in the present exemplary embodiment, the recess 66 is formed continuously around the circumferential direction of the moving member 64. Thus, when a formation portion where the recess 66 is formed in the moving member 64 emerges from the axial direction leading end 582 of the cylinder 58, some part of the recess 66 is guaranteed to face the vehicle width direction outside (the arrow OUT direction in FIG. 3, etc.). This enables the length direction leading end of the stopper 96 to enter inside the recess 66.

### Second Exemplary Embodiment

Next, explanation follows regarding modified examples of the recess 66 in the moving member 64 serving as other exemplary embodiments.

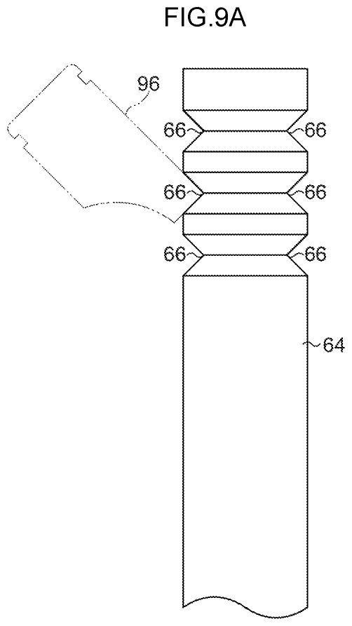

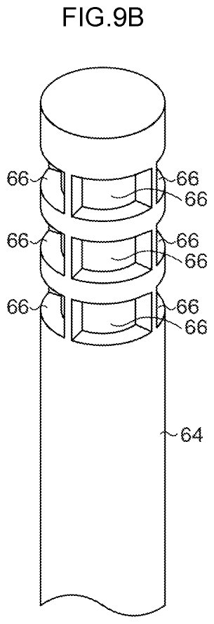

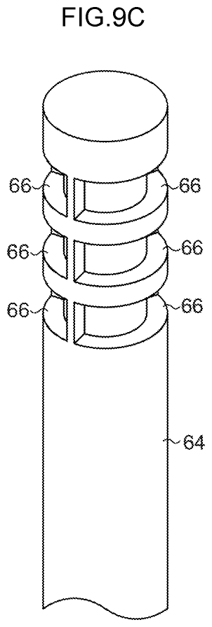

As illustrated in FIG. 9A, in a second exemplary embodiment, the recess 66 has a substantially triangular shape. A width dimension of the recess 66 along the length direction of the moving member 64 decreases on progression toward the central axis side of the moving member 64. In this configuration also, the length direction leading end of the stopper 96 enters inside the recess 66 such that similar operation to that of the first exemplary embodiment is exhibited, and similar advantageous effects to those of the first exemplary embodiment can be obtained.

Note that in the case of such a configuration, if for example the shape of the recess 66 is the same as the shape of a length direction leading end portion of the stopper 96 as illustrated by the imaginary lines (double-dotted dashed lines) in FIG. 9A, the length direction leading end portion of the stopper 96 meshes with the recess 66 when the length direction leading end portion of the stopper 96 enters inside the recess 66. Movement of the moving member 64 toward the length direction leading end side is even more effectively suppressed by the stopper 96 as a result.

### Third and Fourth Exemplary Embodiments

As illustrated in FIG. 9B, in a third exemplary embodiment, plural recesses 66 are formed intermittently in the length direction of the moving member 64 at a length direction base end side portion of the moving member 64. Each of these recesses 66 is split into separate parts around the circumferential direction of the moving member 64 (namely, plural recesses 66 are formed intermittently around the circumferential direction of the moving member 64). As illustrated in FIG. 9C, in a fourth exemplary embodiment, the number of split recesses 66 around the circumferential direction of the moving member 64 is less than in the third exemplary embodiment, and the circumferential direction length of each of the recesses 66 that are split around the circumferential direction of the moving member 64 is longer than the circumferential direction length of each of the recesses 66 that are split around the circumferential direction of the moving member 64 in the third exemplary embodiment.

In these configurations also, the length direction leading end of the stopper 96 enters inside the recess 66 such that similar operation to that of the first exemplary embodiment is exhibited, and similar advantageous effects to those of the first exemplary embodiment can be obtained. Moreover, even if for example the length direction leading end of the stopper 96 cannot enter the recess 66 formed furthest toward the length direction leading end side of the moving member 64, the stopper 96 is able to enter another recess 66 that is second or further away from the length direction leading end side of the moving member 64. Thus, the placement position of the moving member 64 in its initial state does not have to be strictly set.

Note that the recess 66 is formed continuously around the circumferential direction of the moving member 64 in the first exemplary embodiment and the second exemplary embodiment, whereas the plural recesses 66 are formed intermittently around the circumferential direction of the moving member 64 in the third exemplary embodiment and the fourth exemplary embodiment. It is sufficient that the stopper 96 be able to enter inside the recess 66. Namely, it is sufficient that the recess 66 be open toward the vehicle width direction outside (the arrow OUT direction in FIG. 3, etc.) in a state in which the formation portion where the recess 66 is formed to the moving member 64 has emerged from the axial direction leading end 582 of the cylinder 58.

The entire content of the disclosure of Japanese Patent Application No. 2019-200245 filed on Nov. 1, 2019 is incorporated by reference in the present specification. All cited documents, patent applications, and technical standards mentioned in the present specification are incorporated by reference in the present specification to the same extent as if each individual cited document, patent application, or technical standard was specifically and individually indicated to be incorporated by reference.

1. A webbing take-up device, comprising:
a spool configured to take up a webbing of a seatbelt device by being rotated in a take-up direction;
a rotating member configured to rotate the spool in the take-up direction by being rotated toward one side;
a tube-shaped cylinder open at an axial direction leading end side;
a fluid supply unit provided at an axial direction base end side of the cylinder and configured to supply a fluid to an interior of the cylinder in a vehicle emergency;
a moving member provided inside the cylinder and configured to be moved toward the axial direction leading end side of the cylinder, under pressure of the fluid, so as to cause the rotating member to rotate toward the one side by engaging with the rotating member;
an engaging member provided further toward a movement direction side of the moving member than an engagement location of the moving member with the rotating member, the engaging member being configured to be moved toward the engagement location of the moving member with the rotating member by being pressed by a portion of the moving member that has disengaged from the rotating member; and
a recess that is formed in a portion of the moving member located toward the axial direction base end side of the cylinder and that is open toward the engaging member in a state in which the moving member has emerged from the axial direction leading end of the cylinder, the engaging member being configured to enter inside the recess on being pressed and moved by the moving member.

2. The webbing take-up device of claim 1, wherein a plurality of the recesses are provided along the movement direction of the moving member.

3. The webbing take-up device of claim 1, wherein the recess has a ring shape that is continuous around a circumferential direction of the moving member.

4. The webbing take-up device of claim 2, wherein the recess has a ring shape that is continuous around a circumferential direction of the moving member.
